(19) United States
(12) Patent Application Publication
(10) Pub. No.: US 2010/0111288 A1
(43) Pub. Date: May 6, 2010

(54) TIME TO ANSWER SELECTOR AND ADVISOR FOR CALL ROUTING CENTER

(76) Inventors: Hassan Afzal, McLean, VA (US); S. James P. Spottiswoode, Beverly Hills, CA (US)

Correspondence Address: MORRISON & FOERSTER LLP, 755 PAGE MILL RD, PALO ALTO, CA, 94304-1018, US

(21) Appl. No.: 12/266,415

(22) Filed: Nov. 6, 2008

(51) Int. Cl. H04M 3/00

(52) U.S. Cl. 379/265.14

(57) ABSTRACT

Systems and methods are disclosed for routing callers to agents in a contact center, along with an intelligent routing system. An exemplary interface for use with a contact center includes a graphical user element for adjusting a time limit for a caller to be held before routed to an agent according to a pattern matching algorithm where the caller is compared to a set of agents via the pattern matching algorithm and routed to the best matching agent of the set of agents if available prior to the time limit and routed to the best matching agent of available agents if the time limit is exceeded. The interface may further display an estimated effect of the time limit on at least one outcome variable, which may include revenue generation, cost, customer satisfaction, first call resolution, cancellation, or other variable outputs from the pattern matching algorithm(s) of the system.

### CROSS REFERENCE TO RELATED APPLICATION

This application is related to U.S. Ser. No. 12/021,251, filed Jan. 28, 2008, which is hereby incorporated by reference in its entirety for all purposes.

### BACKGROUND

1. Field

The present invention relates generally to the field of routing phone calls and other telecommunications in a contact center system.

2. Related Art

The typical contact center consists of a number of human agents, with each assigned to a telecommunication device, such as a phone or a computer for conducting email or Internet chat sessions, that is connected to a central switch. Using these devices, the agents are generally used to provide sales, customer service, or technical support to the customers or prospective customers of a contact center or a contact center's clients.

Typically, a contact center or client will advertise to its customers, prospective customers, or other third parties a number of different contact numbers or addresses for a particular service, such as for billing questions or for technical support. The customers, prospective customers, or third parties seeking a particular service will then use this contact information, and the incoming caller will be routed at one or more routing points to a human agent at a contact center who can provide the appropriate service. Contact centers that respond to such incoming contacts are typically referred to as “inbound contact centers.”

Similarly, a contact center can make outgoing contacts to current or prospective customers or third parties. Such contacts may be made to encourage sales of a product, provide technical support or billing information, survey consumer preferences, or to assist in collecting debts. Contact centers that make such outgoing contacts are referred to as “outbound contact centers.”

In both inbound contact centers and outbound contact centers, the individuals (such as customers, prospective customers, survey participants, or other third parties) that interact with contact center agents using a telecommunication device are referred to in this application as a “caller.” The individuals acquired by the contact center to interact with callers are referred to in this application as an “agent.”

Conventionally, a contact center operation includes a switch system that connects callers to agents. In an inbound contact center, these switches route incoming callers to a particular agent in a contact center, or, if multiple contact centers are deployed, to a particular contact center for further routing. In an outbound contact center employing telephone devices, dialers are typically employed in addition to a switch system. The dialer is used to automatically dial a phone number from a list of phone numbers, and to determine whether a live caller has been reached from the phone number called (as opposed to obtaining no answer, a busy signal, an error message, or an answering machine). When the dialer obtains a live caller, the switch system routes the caller to a particular agent in the contact center.

### BRIEF SUMMARY

Systems and methods of the present invention can be used to improve or optimize the routing of callers to agents in a contact center. According to one aspect of the present invention an interface is provided for use with an inbound or outbound call routing center for routing callers based on performance of agents and/or pattern matching algorithms between callers and agents. In one example, the interface includes a graphical element (e.g., a selector, slider, text field, or the like) for setting and adjusting a time limit for a time to answer or connect the caller to an agent. For instance, increasing the time limit allows a contact routing system to hold a caller until the best matching agent becomes free. If the time limit is exceeded, the contact routing system operates to route the caller to the best matching agent of those that are available at that time.

Increasing the time to answer and connect a caller, however, may have detrimental effects on the probability of revenue generation or customer satisfaction (not to mention that the caller may simply hang-up or abandon the call). Accordingly, in one example, the interface is further operable to display an estimated effect of the time limit on at least one outcome variable. For instance, the interface is operable to display an estimated revenue generation, cost, customer satisfaction, first call resolution, cancellation, or other outcome variables of the pattern matching algorithm(s) of the system based on a particular time limit for routing the caller. The outcome variables may be estimated based on past call history data, stored algorithms, look-up tables, or the like. Further, the interface may be operable to display an estimated change in the at least one outcome variable if the wait time is changed. For instance, if a contact center user wishes to increase the time limit by two seconds, the interface is operable to display an estimated change in one or more outcome variables. In one example, determining estimates of outcome variables includes evaluating a past time period of the same (or similar) set of agents and constructing a distribution of agent/caller pairs. Using each pair, an expected success rate can be computed via the pattern matching algorithm and applied to current information to estimate probably outcomes (e.g., with respect to one or more of sales, cost, customer satisfaction, etc.).

According to another aspect, a method is provided for routing a caller to an agent, the method including comparing caller data associated with a caller with agent data associated with a set of agents utilizing a pattern matching algorithm. The method further includes causing the caller to be routed to the best matching agent of the set of agents per the pattern matching algorithm if available and if not available holding the caller until the best matching agent becomes available or a time limit for holding the caller is reached. If the time limit is reached, the caller is routed to the best available agent at that time. The method further includes displaying of a graphical element to a user for adjusting the time limit. The method may further display the estimated effect of the time limit or an adjustment thereto on one or more outcome variables of the pattern matching algorithm.

According to another aspect, an apparatus is provided comprising logic for comparing caller data associated with a caller with agent data associated with a set of agents utilizing a pattern matching algorithm. If the best matching agent per the pattern matching algorithm is not available the apparatus is operable to hold the caller until a time limit is reached and cause the caller to be routed to the best available agent of the set of agents if the time limit is exceeded. Further, the apparatus is operable to cause the display of a graphical element with an interface for adjusting the time limit.

Many of the techniques described may be implemented in hardware, firmware, software, or combinations thereof. In one example, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices. Moreover, each program is preferably implemented in a high level procedural or object-oriented programming language to communicate with a computer system. However, the programs can be implemented in assembly or machine language, if desired. In any case, the language may be a compiled or interpreted language.

### BRIEF DESCRIPTION OF THE DRAWINGS

FIG. 1 is a diagram reflecting the general setup of a contact center operation.

FIG. 2 illustrates an exemplary routing system having a routing engine according to one example.

FIG. 3A illustrates an exemplary routing engine for routing callers based on performance based routing and/or pattern matching algorithms.

FIG. 3B illustrates an exemplary method for matching callers and agents using caller data and agent data in a pattern matching algorithm.

FIG. 4 illustrates an exemplary interface having a graphic element for adjusting a time to answer limit for a call routing system.

FIG. 5 illustrates an exemplary interface having a graphic element for adjusting a time to answer limit for a call routing system, and further operable to display estimated effects on output variables for a selected time to answer limit.

FIG. 6 illustrates a typical computing system that may be employed to implement some or all processing functionality in certain embodiments of the invention.

### DETAILED DESCRIPTION OF THE INVENTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

According to one aspect of the present invention, a displayed computer interface for setting and changing a limit time for holding a caller (or “time to answer” limit) is described. Increasing the time may allow for the best or a better matching agent per a performance based, pattern matching algorithm, or computer model to become available for connection with the caller. The time limit can be altered in real time or at a predetermined time in the future, and estimated effects of the time limit or changes thereto on outcomes of the system may be displayed to a user. Initially, exemplary call routing systems and methods utilizing performance based, pattern matching algorithms, and/or computer models are described for routing callers to available agents. This description is followed by exemplary interfaces and methods for setting and adjusting a time to answer limit to allow the call routing system to find an agent match for a caller.

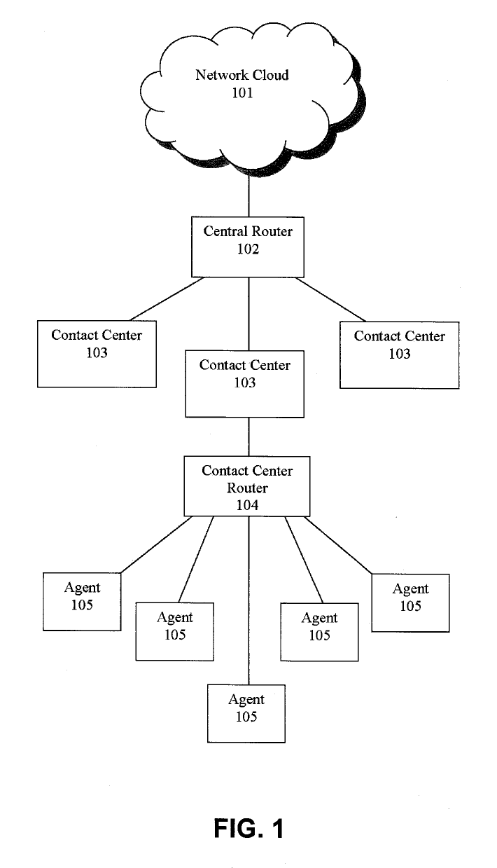

FIG. 1 is a diagram reflecting the general setup of a contact center operation 100. The network cloud 101 reflects a specific or regional telecommunications network designed to receive incoming callers or to support contacts made to outgoing callers. The network cloud 101 can comprise a single contact address, such as a telephone number or email address, or multiple contract addresses. The central router 102 reflects contact routing hardware and software designed to help route contacts among call centers 103. The central router 102 may not be needed where there is only a single contact center deployed. Where multiple contact centers are deployed, more routers may be needed to route contacts to another router for a specific contact center 103. At the contact center level 103, a contact center router 104 will route a contact to an agent 105 with an individual telephone or other telecommunications equipment 105. Typically, there are multiple agents 105 at a contact center 103, though there are certainly embodiments where only one agent 105 is at the contact center 103, in which case a contact center router 104 may prove to be unnecessary.

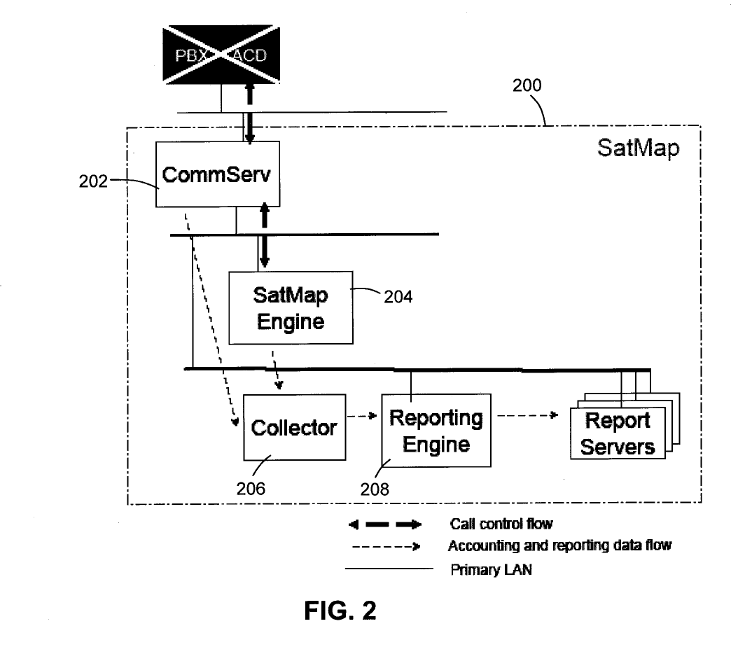

FIG. 2 illustrates an exemplary contact center routing system 200 (which may be included with contact center router 104 of FIG. 1). Broadly speaking, routing system 200 is operable to match callers and agents based, at least in part, on agent performance, pattern matching algorithms or computer models using caller data and/or agent data, and the like. Routing system 200 may include a communication server 202 and a routing engine 204 (referred to at times as “SatMap” or “Satisfaction Mapping”) for receiving and matching callers to agents.

Routing engine 204 may operate in various manners to match callers to agents based on performance data of agents, pattern matching algorithms, and computer models, which adapt over time based on the performance or outcomes of previous caller-agent matches. In one example, the routing engine 204 includes a neural network based adaptive pattern matching engine. Various other exemplary pattern matching and computer model systems and methods which may be included with content routing system and/or routing engine 204 are described in U.S. Ser. No. 12/021,251, filed Jan. 28, 2008, and U.S. Ser. No. U.S. patent application Ser. No. 12/202,091, filed Aug. 29, 2008, both of which are hereby incorporated by reference in their entirety. Of course, it will be recognized that other performance based or pattern matching algorithms and methods may be used alone or in combination with those described here.

Routing system 200 may further include other components such as collector 206 for collecting caller data of incoming callers, data regarding caller-agent pairs, outcomes of caller-agent pairs, agent data of agents, and the like. Further, routing system 200 may include a reporting engine 208 for generating reports of performance and operation of the routing system 200. Various other servers, components, and functionality are possible for inclusion with routing system 200. Further, although shown as a single hardware device, it will be appreciated that various components may be located remotely from each other (e.g., communication server 202 and routing engine 204 need not be included with a common hardware/server system or included at a common location). Additionally, various other components and functionality may be included with routing system 200, but have been omitted here for clarity.

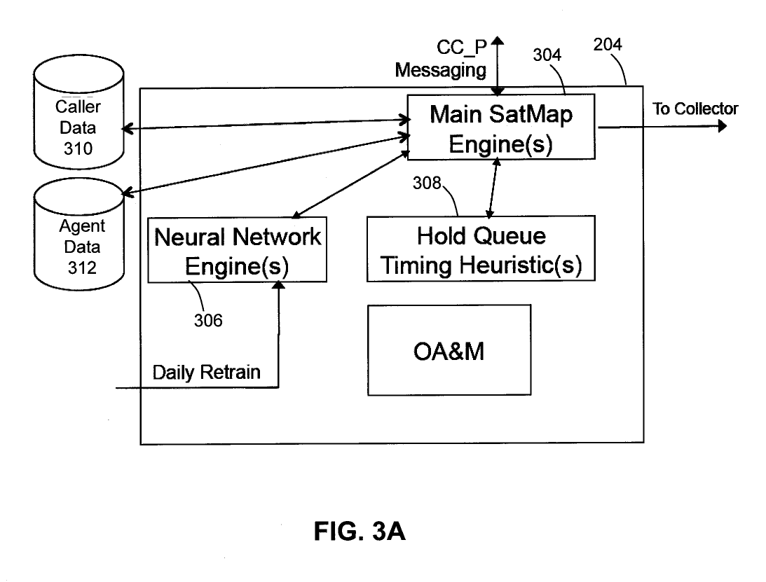

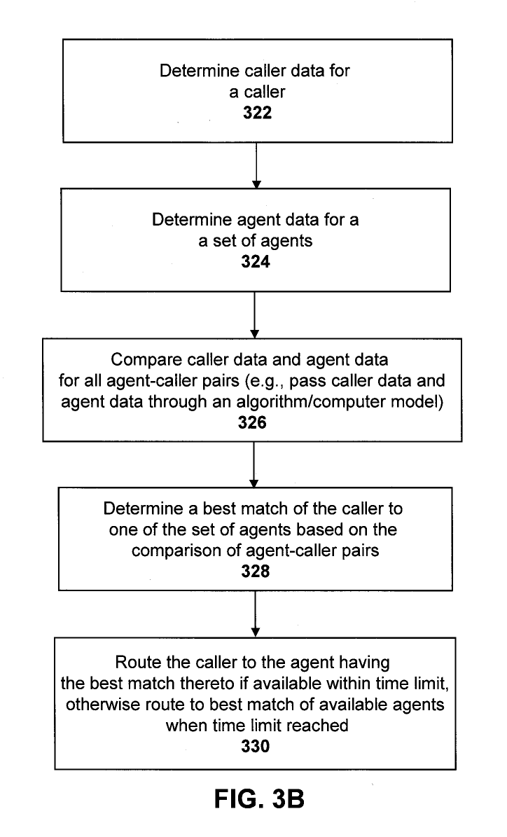

FIG. 3A illustrates detail of exemplary routing engine 204. Routing engine 204 includes a main mapping engine 304, which receives caller data and agent data from databases 310 and 312. In some examples, routing engine 204 may route callers based solely or in part on performance data associated with agents. In other examples, routing engine 204 may make routing decisions based solely or in part on comparing various caller data and agent data, which may include, e.g., performance based data, demographic data, psychographic data, and other business-relevant data. Additionally, affinity databases (not shown) may be used and such information received by routing engine 204 for making routing decisions.

Routing engine 204 further includes or is in communication with timing heuristic logic 308, which determines the time to answer limit, e.g., how long a caller is held as routing engine 204 determines and waits for the best matching agent for routing the caller. For instance, in a case where the best matching agent is busy (e.g., with another call, post call processing, or the like), increasing the time to answer increases the chance that the best (or a better matching agent) becomes available for routing relative to the then available agent(s). In other words, if a caller is held for a longer period of time, the best matching agent may become available for the caller. Of course, if a caller is held too long it may have a negative effect on revenue or customer satisfaction, for example. In one example, described herein, the caller wait time is adjustable by a user and further provides an estimation to the user as to the effects on cost, revenue, customer satisfaction, and the like.

In one example, routing engine 204 further includes or is in communication with one or more neural network engines 306. Neural network engines 306 may receive caller and agent data directly or via routing engine 204 and operate to match and route callers based on pattern matching algorithms and computer models generated to increase the changes of desired outcomes. Further, as indicated in FIG. 3A, call history data (including, e.g., caller-agent pair outcomes with respect to cost, revenue, customer satisfaction, etc.) may be used to retrain or modify the neural network engine 306 periodically, e.g., daily or weekly.

Exemplary methods for routing callers to agents include rating agents on performance, comparing agent data and caller data and matching per a pattern matching algorithm, creating computer models to predict outcomes of agent-caller pairs, or combination thereof. FIG. 3B illustrates an exemplary method for increasing the chances of an optimal interaction by combining agent grades (which may be determined from grading or ranking agents on desired outcomes), agent demographic data, agent psychographic data, and other business-relevant data about the agent (individually or collectively referred to in this application as “agent data”), along with demographic, psychographic, and other business-relevant data about callers (individually or collectively referred to in this application as “caller data”). Agent and caller demographic data can comprise any of: gender, race, age, education, accent, income, nationality, ethnicity, area code, zip code, marital status, job status, credit score, and the like. Agent and caller psychographic data can comprise any of introversion, sociability, desire for financial success, film and television preferences, and the like.

In one example, a method for operating a contact center includes determining caller data associated with a caller (e.g., a caller on hold), determining agent data associated with a set of agents (e.g., available and busy agents), comparing the agent data and the caller data (e.g., via a pattern matching algorithm), and matching the caller to an agent to increase the chance of an optimal interaction. In particular, at 322, caller data (such as a caller demographic or psychographic data) is identified for a caller. One way of accomplishing this is by retrieving caller data from available databases by using the caller's contact information as an index. Available databases include, but are not limited to, those that are publicly available, those that are commercially available, or those created by a contact center or a contact center client. In an outbound contact center environment, the caller's contact information is generally known beforehand. In an inbound contact center environment, the caller's contact information can be retrieved by examining the caller's CallerID information or by requesting this information of the caller at the outset of the contact, such as through entry of a caller account number or other caller-identifying information. Other business-relevant data such as historic purchase behavior, current level of satisfaction as a customer, or volunteered level of interest in a product may also be retrieved from available databases.

At 324, agent data for a set of agents is identified or determined. One method of determining agent demographic or psychographic data can involve surveying agents at the time of their employment or periodically throughout their employment. Such a survey process can be manual, such as through a paper or oral survey, or automated with the survey being conducted over a computer system, such as by deployment over a web-browser. In some example, the method uses agent grades, demographic, psychographic, and other business-relevant data, along with caller demographic, psychographic, and other business-relevant data, other embodiments of the exemplary methods and systems can eliminate one or more types or categories of caller or agent data to reduce the time to answer, computing power, or storage necessary.

The agent data and caller data may then be compared at 326. For instance, the agent data and caller data can be passed to a computational system for comparing caller data to agent data for each agent-caller pair, i.e., the caller data and agent data is compared in a pair-wise fashion for each potential routing decision. In one example, the comparison is achieved by passing the agent and caller data to a pattern matching algorithm to create a computer model that matches each caller with each agent and estimates the probable outcome of each matching along a number of optimal interactions, such as the generation of a sale, the duration of contact, or the likelihood of generating an interaction that a customer finds satisfying.

The pattern matching algorithm to be used in the exemplary methods and system can comprise any correlation algorithm, such as a neural network algorithm or a genetic algorithm. To generally train or otherwise refine the algorithm, actual contact results (as measured for an optimal interaction) are compared against the actual agent and caller data for each contact that occurred. The pattern matching algorithm can then learn, or improve its learning of, how matching certain callers with certain agents will change the chance of an optimal interaction. In this manner, the pattern matching algorithm can then be used to predict the chance of an optimal interaction in the context of matching a caller with a particular set of caller data, with an agent of a particular set of agent data. Preferably, the pattern matching algorithm is periodically refined as more actual data on caller interactions becomes available to it, such as periodically training the algorithm every night after a contact center has finished operating for the day.

The pattern matching algorithm may create or use a computer model reflecting the predicted chances of an optimal interaction for each agent and caller matching. Preferably, the computer model will comprise the predicted chances for a set of optimal interactions for every agent that is logged in to the contact center as matched against every available caller. Alternatively, the computer model can comprise subsets of these, or sets containing the aforementioned sets. For example, instead of matching every agent logged into the contact center with every available caller, examples can match every available agent with every available caller, or even a narrower subset of agents or callers. Likewise, the present invention can match every agent that ever worked on a particular campaign—whether available or logged in or not—with every available caller. Similarly, the computer model can comprise predicted chances for one optimal interaction or a number of optimal interactions and weight them in various fashions.

A computer model can also comprise a suitability score for each matching of an agent and a caller. The suitability score can be determined by taking the chances of a set of optimal interactions as predicted by the pattern matching algorithm, and weighting those chances to place more or less emphasis on a particular optimal interaction as related to another optimal interaction. The suitability score can then be used in the exemplary methods and systems to determine which agents should be connected to which callers.

Based on the pattern matching algorithm and/or computer model, the method further includes determining the agent having the best match to the caller at 328. As will be understood, the best matching agent may depend on the pattern matching algorithm, computer model, and desired output variables and weightings selected by a particular call center. The caller is then routed to the best matching agent at 330 if the agent is available within the time limit set for the time to answer. If the time limit is exceeded, however, the method and system may operate to route the caller to the then best matching agent, i.e., the best matching agent of available agents, as determined by the system. In some examples, the system may generate a ranking of agents for a particular caller and connect to the caller to the highest ranking available agent when the time limit is reached.

According to another aspect of the exemplary systems and methods described, a visual computer interface and printable reports may be provided to the contact center or their clients to allow them to, in a real-time or a past performance basis, monitor the statistics of agent to caller matches, measure the optimal interactions that are being achieved versus the interactions predicted by the computer model, as well as any other measurements of real time or past performance using the methods described herein. A visual computer interface for changing the time to answer (as well as the weighting on an optimal interaction) can also be provided to the contact center or the contact center client, such that they can, as discussed herein, monitor or change the time to answer as well as view an estimated effect on outcome variables.

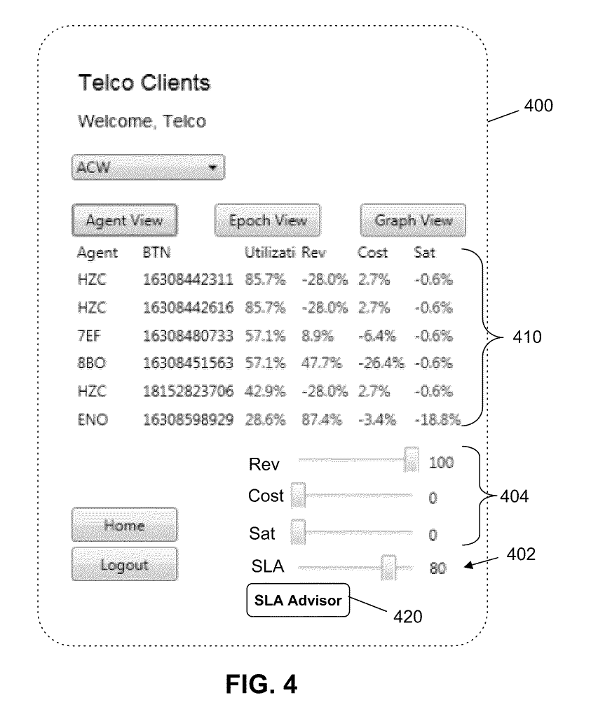

FIG. 4 illustrates an exemplary interface 400 having a graphic element 402 for adjusting a time to answer limit for callers. It will be recognized that interface 400 may be displayed within a browser page, portal page, or standalone user interface for a contact center routing system. Additionally, various other information and functionality may be included with interface 400, but is omitted here for clarity.

In this example, interface 400 displays a report of call center performance broken down by different agents at 410 (and which may also be broken down by time periods or display various graphs, which are not shown). Interface 400 further includes settings for desired outcomes of different variables of the pattern matching algorithms and computer models being used for routing callers to agents at 404. In particular, sliders 404 include sliders for adjusting the weightings of revenue, cost, and customer satisfaction in the call center routing algorithms and computer models (note that the value for the three sliders equals 100). Various weighting methods and algorithms are described, for example, in copending U.S. patent application Ser. No. 12/202,091, filed Aug. 29, 2008, which is incorporated herein by reference in its entirety. Of course, various other pattern matching algorithms, computer models, and weighting methods for adjusting the desired outcomes are possible and contemplated.

Interface 400 further includes slider 402, which operates to adjust the time to answer limit relative to a Service Level Agreement (“SLA”) time limit. For instance, an SLA may dictate a time to answer limit of two seconds. In this example, if slider 402 is set to 100 the system determines the best matching agent for a caller and then waits (or holds the caller) for the SLA limit if the best matching agent is not available and routes the caller to the best-then available agent when the limit is exceeded. Note, if the best then available agent is available, the system routes the caller prior to the time to answer limit. If slider 402 is set to 50, however, the system might double the time to answer limit. If slider 402 is set to zero, the system may wait without regard to the SLA time limit until the best matching agent is available. In other examples, slider 402 may include actual times without reference to an SLA limit or the like. For example, slider 402 can range from a minimum wait time (e.g., 0.1 seconds) to a maximum time (e.g., 1 minute, 5 minutes, or more).

Slider 402 may operate to change the wait time in response to click-and-drag operations with a mouse, input to a key board (e.g., arrow keys, numerical entries, and so on). Further, the “slider” may be replaced with an entry field for manually entering times or values, up-and-down arrows for adjusting the time, and so on.

As described, increasing the wait time allows time for the best or a better matching agent to become free for connection with the caller. Increasing the time to answer, however, may lead to changes in various outcomes of the call such as revenue, cost, and customer satisfaction. For example, increasing the time to answer time may negatively impact the customer satisfaction outcome of the call as well as increase the change of the caller abandoning the call. Accordingly, and in one example, interface 400 includes an SLA advisor 420, which when selected provides various information on the selected wait time and/or changes in the wait time with respect to outcome variables, such as the estimated effect of changing the wait time on revenue, cost, and customer satisfaction.

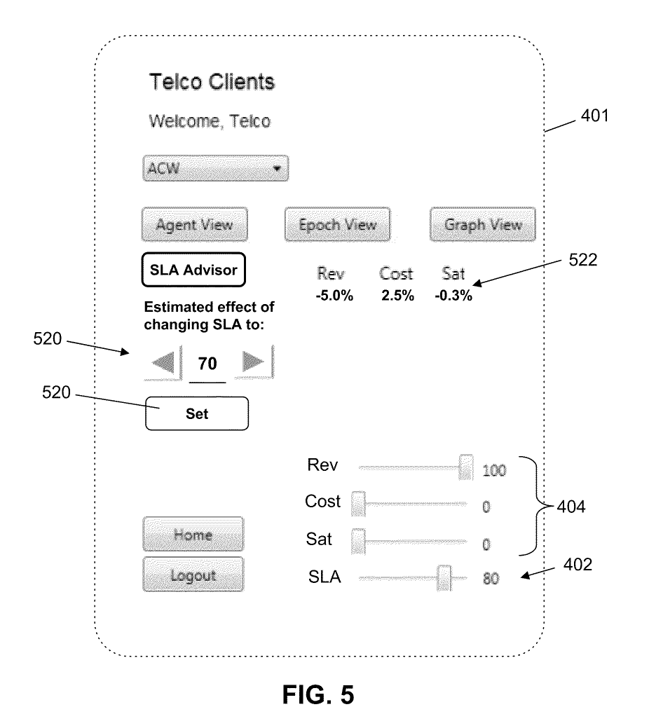

FIG. 5 illustrates exemplary interface 401 having a graphic element 402 for adjusting a time to answer limit for callers and operable for illustrating estimated effects on output variables for a set or adjusted time to answer limit. In particular, at 520 a user may adjust the wait time (or value) by selecting the arrows or inputting a number directly. As the input time is changed, the estimated effect to selected outcome variables is shown at 522. In this instance illustrating to a user that changing the time from 80 to 70 results in a decrease in revenue, increase in cost, and decrease in customer satisfaction. When the user is satisfied with the change or setting of the time the user may select “set” at 520.

Various estimation methods and algorithms for estimating outcome variables are described, for example, in copending U.S. provisional Patent application Ser. No. 61/084,201, filed on Jul. 28, 2008, and which is incorporated herein by reference in its entirety. In one example, the estimate includes evaluating a past time period of the same (or similar) set of agents and constructing a distribution of agent/caller pairs. Using each pair, an expected success rate can be computed via the pattern matching algorithm and applied to current information to estimate current performance (e.g., with respect to one or more of sales, cost, customer satisfaction, etc.). Accordingly, taking historical call data and agent information the algorithm can compute estimates of changing the time limit with the pattern matching algorithm. It is noted that a comparable time (e.g., time of day, day of the week etc.) for the historical information may be important as performance will likely vary with time. In other examples, stored algorithms or look-up tables may be used to estimate the change in output variables.

Many of the techniques described here may be implemented in hardware or software, or a combination of the two. Preferably, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices. Moreover, each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

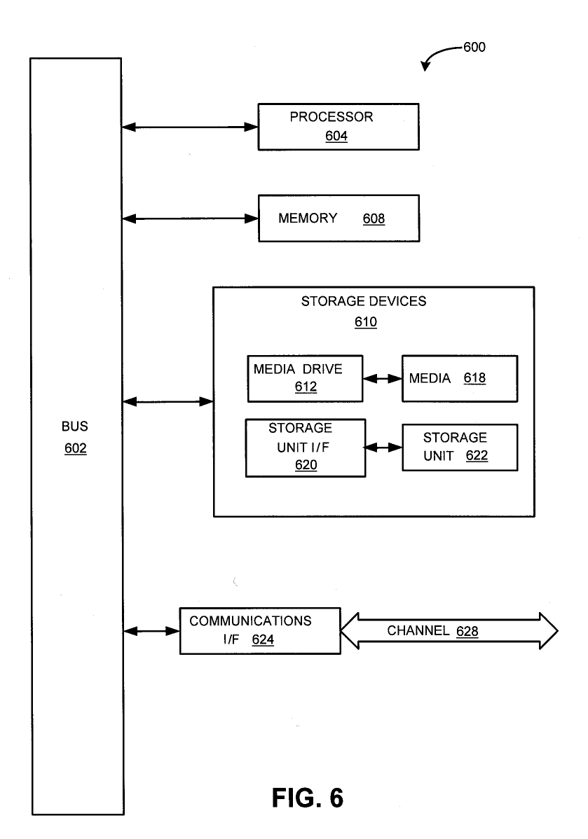

FIG. 6 illustrates a typical computing system 600 that may be employed to implement processing functionality in embodiments of the invention. Computing systems of this type may be used in clients and servers, for example. Those skilled in the relevant art will also recognize how to implement the invention using other computer systems or architectures. Computing system 600 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 600 can include one or more processors, such as a processor 604. Processor 604 can be implemented using a general or special purpose processing engine such as, for example, a microprocessor, microcontroller or other control logic. In this example, processor 604 is connected to a bus 602 or other communication medium.

Computing system 600 can also include a main memory 608, such as random access memory (RAM) or other dynamic memory, for storing information and instructions to be executed by processor 604. Main memory 608 also may be used for storing temporary variables or other intermediate information during execution of instructions to be executed by processor 604. Computing system 600 may likewise include a read only memory (“ROM”) or other static storage device coupled to bus 602 for storing static information and instructions for processor 604.

The computing system 600 may also include information storage system 610, which may include, for example, a media drive 612 and a removable storage interface 620. The media drive 612 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 618 may include, for example, a hard disk, floppy disk, magnetic tape, optical disk, CD or DVD, or other fixed or removable medium that is read by and written to by media drive 612. As these examples illustrate, the storage media 618 may include a computer-readable storage medium having stored therein particular computer software or data.

In alternative embodiments, information storage system 610 may include other similar components for allowing computer programs or other instructions or data to be loaded into computing system 600. Such components may include, for example, a removable storage unit 622 and an interface 620, such as a program cartridge and cartridge interface, a removable memory (for example, a flash memory or other removable memory module) and memory slot, and other removable storage units 622 and interfaces 620 that allow software and data to be transferred from the removable storage unit 618 to computing system 600.

Computing system 600 can also include a communications interface 624. Communications interface 624 can be used to allow software and data to be transferred between computing system 600 and external devices. Examples of communications interface 624 can include a modem, a network interface (such as an Ethernet or other NIC card), a communications port (such as for example, a USB port), a PCMCIA slot and card, etc. Software and data transferred via communications interface 624 are in the form of signals which can be electronic, electromagnetic, optical or other signals capable of being received by communications interface 624. These signals are provided to communications interface 624 via a channel 628. This channel 628 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to physical, tangible media such as, for example, memory 608, storage media 618, or storage unit 622. These and other forms of computer-readable media may be involved in storing one or more instructions for use by processor 604, to cause the processor to perform specified operations. Such instructions, generally referred to as “computer program code” (which may be grouped in the form of computer programs or other groupings), when executed, enable the computing system 600 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 600 using, for example, removable storage media 618, drive 612 or communications interface 624. The control logic (in this example, software instructions or computer program code), when executed by the processor 604, causes the processor 604 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

The above-described embodiments of the present invention are merely meant to be illustrative and not limiting. Various changes and modifications may be made without departing from the invention in its broader aspects. The appended claims encompass such changes and modifications within the spirit and scope of the invention.

We claim:

1. An interface for use with a call-center routing system, the interface comprising:
a graphical user element for adjusting a time limit for a caller to be held before routed to an agent according to a routing engine comprising at least one pattern matching algorithm, wherein:
caller data associated with the caller is compared to agent data associated with a set of agents via the pattern matching algorithm and routed to the best matching agent of the set of agents if available prior to the time limit, and
the caller is routed to the best matching agent of available agents if the time limit is exceeded.

2. The interface of claim 1, wherein the interface is further operable to display an estimated effect of the time limit on at least one outcome variable.

3. The interface of claim 2, wherein the at least one outcome variable comprises one or more of cost, revenue, or customer satisfaction.

4. The interface of claim 1, wherein the graphical element comprises a slider.

5. The interface of claim 1, wherein the time limit comprises a value in relation to a service level agreement time limit.

6. The interface of claim 1, wherein the routing engine comprises logic for routing callers to agents based on agent performance data.

7. The interface of claim 1, wherein the routing engine comprises a neural network engine.

8. A method for routing callers to agents in a call-center routing environment, the method comprising the acts of:
comparing caller data associated with a caller with agent data associated with a set of agents utilizing a pattern matching algorithm; and
causing the caller to be routed to the best matching agent of the set of agents per the pattern matching algorithm if available prior to a time limit; and
if the best matching agent is not available prior to the time limit, causing the caller to be routed to the best matching agent of available agents, wherein the time limit is adjustable via a displayed graphical element.

9. The method of claim 8, further comprising causing the display of an estimated effect of the time limit on at least one outcome variable.

10. The method of claim 9, wherein the at least one outcome variable comprises one or more of cost, revenue, or customer satisfaction.

11. The method of claim 8, wherein the displayed graphical element comprises a slider.

12. The method of claim 8, wherein the time limit comprises a value in relation to a service level agreement time limit.

13. The method of claim 8, further comprising routing callers to agents based on agent performance data.

14. The method of claim 8, wherein the pattern matching algorithm further comprises a neural network algorithm.

15. Apparatus for routing callers to agents in a call center routing environment, the apparatus comprising logic for:
comparing caller data associated with a caller with agent data associated with a set of agents utilizing a pattern matching algorithm;
causing the caller to be routed to the best matching agent of the set of agents based on the pattern matching algorithm if available and if not available holding the caller until the best matching agent becomes available or a time limit is reached;
causing the caller to be routed to the best available agent of the set of agents if the time limit is exceeded; and
causing the display of a graphical element with an interface for adjusting the time limit.

16. The apparatus of claim 15, further comprising logic for causing the display of an estimated effect of the time limit on at least one outcome variable.

17. The apparatus of claim 16, wherein the at least one outcome variable comprises one or more of cost, revenue, or customer satisfaction.

18. The apparatus of claim 15, wherein the displayed graphical element comprises a slider.

19. The apparatus of claim 15, wherein the time limit comprises a value in relation to a service level agreement time limit.

20. The apparatus of claim 15, further comprising routing callers to agents based on agent performance data.

21. The apparatus of claim 15, wherein the pattern matching algorithm further comprises a neural network algorithm.

22. Computer readable storage medium comprising computer readable instructions for carrying out the method of:
comparing caller data associated with a caller with agent data associated with a set of agents utilizing a pattern matching algorithm;
causing the caller to be routed to the best matching agent of the set of agents based on the pattern matching algorithm if available and if not available holding the caller until the best matching agent becomes available or a time limit is reached;
causing the caller to be routed to the best available agent of the set of agents if the time limit is exceeded; and
causing the display of a graphical element with an interface for adjusting the time limit.

23. The computer readable storage medium of claim 22, further comprising instructions for causing the display of an estimated effect of the time limit on at least one outcome variable.

24. The computer readable storage medium of claim 23, wherein the at least one outcome variable comprises one or more of cost, revenue, or customer satisfaction.

25. The computer readable storage medium of claim 22, wherein the displayed graphical element comprises a slider.

26. The computer readable storage medium of claim 22, wherein the time limit comprises a value in relation to a service level agreement time limit.

27. The computer readable storage medium of claim 22, further comprising routing callers to agents based on agent performance data.

28. The computer readable storage medium of claim 22, wherein the pattern matching algorithm further comprises a neural network algorithm.
